(19) United States
(12) Patent Application Publication
(10) Pub. No.: US 2021/0011200 A1
(43) Pub. Date: Jan. 14, 2021

(54) FUNCTIONAL CONTACT LENS AND METHOD FOR DYEING THE SAME

(71) Applicant: VIZIONFOCUS INC., Miaoli County (TW)

(72) Inventors: Wen-Ching LIN, Miaoli County (TW); Ching-Fang LEE, Miaoli County (TW); Chi-Ching CHEN, Miaoli County (TW); Yan-Zuo LIN, Miaoli County (TW)

(21) Appl. No.: 16/663,375

(22) Filed: Oct. 25, 2019

(30) Foreign Application Priority Data
Jul. 9, 2019 (TW) 108124060

(51) Int. Cl. G02B 1/12; G02C 7/02; G02C 7/04; G02B 1/04; C09D 7/41

(52) U.S. Cl. CPC G02B 1/12; G02C 7/021; G02C 13/008; G02B 1/043; C09D 7/41; G02C 7/04

(57) ABSTRACT

A method for dyeing a functional contact lens includes steps of: providing a lens body; formulating a first solution, wherein the first solution is an ionic salt solution containing an alkali; placing the lens body in the first solution and reacting at 30° C. to 80° C.; formulating a second solution, wherein the second solution is an ionic salt solution containing at least one reactive dye; and placing the lens body in the second solution and reacting at 30° C. to 80° C.; wherein the at least one reactive dye reacts with the lens body to be fixed to a surface portion of the lens body. In order to achieve one or a portion or all of the above or other objects, the present invention further provides a functional contact lens including a lens body and a dye layer on a surface of the lens body and can be obtained by the aforementioned method.

### FIELD OF THE INVENTION

The present invention relates to a contact lens and a method for dyeing the same, and more particularly to a functional contact lens and a method for dyeing the same.

### BACKGROUND OF THE INVENTION

Contact lenses have been commercialized for 60 years after invented in the early 1950s. The original contact lenses are made of hard materials such as poly methyl methacrylate (PMMA). Due to its hard material and poor oxygen permeability and hydrophilicity, the contact lens can be worn for a short period of time and has a significant foreign matter discomfort. The contact lenses have a progressive reform when the soft contact lenses were invented in the mid-1970s. The soft contact lenses are made from a water-based hydrogel material such as 2-hydroxyethyl methacrylate (HEMA). Due to its high water absorption, the material forms a soft, high water-containing property after hydration, which greatly enhances the wearing comfort but its oxygen permeability is still low and it can only be worn for 8 to 12 hours a day. Corneal hypoxic edema and neovascularization often occur after prolonged wear. Taiwan has a small territory but big population, and therefore the living space is relatively small and the pressure of school is heavy. As a result, the abnormal population of visual acuity is rapidly increasing. Abnormal vision can be corrected by wearing glasses; however, wearing glasses often causes inconvenience in daily life, so people prefers use contact lenses for vision correction. Contact lenses are worn directly on the cornea and adjacent marginal or scleral areas of the eye to correct vision or as a device for keratoplasty. The development of the product has gradually evolved from the hardest materials such as glass and PMMA to hydrophilic HEMA, and the future development trend is towards the long-lasting silicone hydrogel.

With the development of science and technology, electronic products such as LED lights, tablet computers, TVs, and smart phones release blue light. The eyes may look directly at the blue light emitted by the screen when using 3C products. Blue light is the part of the visible light that is closest to the ultraviolet light, and its wavelength is between 380 nm and 530 nm. The shorter wavelength will be focused in front of the retina in advance, which will cause scattering. Therefore, the eye needs to focus more and cannot relax, and long time looking the screen can easily lead to eye contrast and clarity reduction and increase eye fatigue. Further, blue light is not absorbed by the cornea and the crystal s when it is injected into the eye and can penetrate the cornea and the crystal directly into the macula. If the eye absorbs too much blue light, it will cause stinging, photophobia and other symptoms in the early stage and will cause inflammation and edema of the macula in the long-term, which may form a drusen in the center of the macula. Once the drusen causes bleeding, it will cause central vision defect and cannot seeing things clearly. Therefore, with the changes in modern life and the long-term exposure to blue light, the age group of macular degeneration that often occurred in the elderly has a tendency to decline. Anti-blue light has become an important issue.

The anti-blue-light contact lens commonly known is a kind of anti-blue and anti-UV contact lens disclosed by the Republic of China Patent No. M487455 “Colored contact lens with blue light filtering and anti-UV function”, which is composed of upper, middle and lower lenses. The filtering blue light coating agent in the upper lens is used to reduce the blue light penetrating contact lens directly on the eye. The filtering blue light coating agent is not legally added to the contact lens according to the safety scope of the FDA, and there will be doubts that hurt the eyes. Further, adding the filtering blue light coating agent to the contact lens is time consuming, labor intensive and costly and there is no mass production efficiency.

The Republic of China Patent No. I554803 discloses a method for simplifying the process and consistently producing anti-blue light contact lenses capable of anti-blue light and anti-ultraviolet light. In the method, one or more dyes of yellow, orange, red, green, etc. are adjusted according to the color and the proportion of the dye. Or, the blue light absorber is added to the contact lens hydrogel or the silicon hydrogel monomer. Then, mold molding or spin-forming and other processes are performed. After the dry sheet is solidified, it is thrown into the hydration tank for color fixing and hydration extraction to complete the anti-blue light contact lens. However, this invention is not suitable for high-concentration dyes because it also blocks the UV-visible onset reaction (wavelength 380 nm 400 nm) and cannot be polymerized to form a lens.

In summer, 380-390 nm ultraviolet light has short wavelength and high energy, and long-term exposure to the sun may cause macular lesions, cataracts, retinopathy, keratitis (light damage) and other injuries. Therefore, a suitable pair of sports sunglasses has become one of the most important equipment for summer sports. The advantage of wearing sunglasses is to prevent the sun from over-irritating the eyes, filtering ultraviolet and infrared rays, avoiding damage to the optic nerve, helping to improve visual contrast sensitivity, reducing reflection glare, and increasing color contrast. Further, wearing sunglasses can help improve problems with eye photophobia, dry eye, early cataract, and conjunctival inflammation.

From the above, it is known that whether it is to produce an anti-blue light or sport sun contact lens, the proper selection of the dye/absorbent and the dyeing method are quite important. The present invention therefore proposes the following dyeing method and the manufactured contact lens.

### SUMMARY OF THE INVENTION

The present invention provides a method for dyeing a functional contact lens, which can fix the reactive dye on the surface portion of the lens body and help to improve the color uniformity of the appearance of the lens.

The present invention provides a method for dyeing a functional contact lens, which controls the thickness of the dye layer.

The present invention provides a functional contact lens, which is anti-blue light and exhibits better color uniformity in appearance.

Other objects and advantages of the present invention will become apparent from the technical features disclosed herein.

In order to achieve one or a portion or all of the above or other objects, the present invention provides a method for dyeing a functional contact lens, which includes steps of: providing a lens body; formulating a first solution, wherein the first solution is an ionic salt solution containing an alkali; placing the lens body in the first solution and reacting at 30° C. to 80° C.; formulating a second solution, wherein the second solution is an ionic salt solution containing at least one reactive dye; and placing the lens body in the second solution and reacting at 30° C. to 80° C.; wherein the at least one reactive dye reacts with the lens body to be fixed to a surface portion of the lens body. In order to achieve one or a portion or all of the above or other objects, the present invention further provides a functional contact lens, which includes a lens body and a dye layer disposed on a surface portion of the lens body. The functional contact lens can be obtained by the method including the foregoing steps.

In order to achieve one or a portion or all of the above or other objects, the present invention further provides a functional contact lens including a lens body and a dye layer disposed on a surface portion of the lens body. The lens body includes a concave surface and a convex surface. The dye layer extends from the concave surface toward an inside of the lens body by a first thickness and extends from the convex surface toward the inside of the lens body by a second thickness. A sum of the first thickness and the second thickness is less than 40 μm. Light having a wavelength in a range of 380 nm to 500 nm has a shielding ratio greater than 5% for the functional contact lens.

The method for dyeing a functional contact lens provided by the present invention uses the first solution and then uses the second solution. As such, the procedure of alkali first and then dyeing facilitates the fixation of the dye on the surface portion of the lens body. The resulting functional contact lens is resistant to blue light and safe, and is also suitable as sun contact lenses.

The above and other objects, features, and advantages of the present invention will become more apparent from the description of the preferred embodiments and the accompanying drawings.

### BRIEF DESCRIPTION OF THE DRAWINGS

FIG. 1 is a flow chart showing a method for dyeing a functional contact lens according to an embodiment of the present invention;

FIG. 2 is a schematic cross-sectional view of a functional contact lens according to an embodiment of the present invention;

FIG. 3A is a cross-sectional view of a functional contact lens according to an embodiment of the present invention;

FIG. 3B is a cross-sectional view of a lens body according to an embodiment of the present invention;

FIG. 4A is a graph showing the relationship between light wavelength and transmittance of a functional contact lens according to an embodiment of the present invention;

FIG. 4B is a graph showing the relationship between light wavelength and transmittance of a functional contact lens according to another embodiment of the present invention; and

FIG. 4C is a graph showing the relationship between light wavelength and transmittance of a lens body according to an embodiment of the invention.

### DETAILED DESCRIPTION OF PREFERRED EMBODIMENTS

The above and other technical contents, features and advantages of the present invention will be apparent from the following detailed description of the preferred embodiments. The directional terms mentioned in the following embodiments, such as up, down, left, right, front or back, etc., are only directions referring to the additional drawings. Therefore, the directional terminology used is for the purpose of illustration and not limitation.

In the following description, the “lens body” or “lens wet film body” is defined as commercially available transparent, aqua blue or colored hydrogel or silicon hydrogel contact lenses. Hydrogel or hydrophobic may include any of the conventional hydrogel components may be selected form a group consisting of such as hydroxyethyl methacrylate (HEMA), hydroxypropyl methacrylate (HPMA), methyl methacrylate (MMA), glyceryl methacrylate (GMA), N-vinyl pyrrolidone (NVP), N,N′-dimethylacrylamide (DMA), N,N′-diethylacrylamide, N-isopropylacrlamide, 2-hydroxyethyl acrylate, vinyl acetate, N-acryloymorpholine, 2-dimethlaminoethylacrylate, or a combination thereof.

“Silicon hydrogel monomer” can be silicon-containing monomers or other hydrophobic monomers capable of closing to the surface free energy of silicon hydrogel materials, such as MMA/ethyl methacrylate or styrene. The silicon-containing monomer may also be a material option of the silicon hydrogel constituting the lens body or the lens wet film body, and may be selected from a group consisting of, but not limited to, tris(trimethylphosphonioalkyl) methacrylate (TRIS), bis(trimethylsiloxy)methylsilylpropyl methacrylate, pentamethyldimethoxypropane-pentamethyldisiloxanepropyl methacrylate, pentamethyldisiloxanylmethylmethacrylate, tris (trimethylsiloxy) silylpropyloxyethyl methacrylate, tris(trimethylsiloxy)silylpropylmethacryloxyethylcarbamate (TSMC), tris(trimethylsiloxy)silypropyl glycerol methacrylate (SIGMA), tris(polydimethylsiloxy)silylpropyl methacrylate or a combination of thereof.

“Ionic salt solution (containing alkali)” includes one or more alkali such as sodium carbonate, sodium bicarbonate, sodium hydroxide, potassium carbonate, boric acid, sodium tetraborate. In the dyeing of the lens body or the lens wet film body, the role of the alkali is to help the dye form a covalent bond with the lens, which has the effect of color fixing. The ionic salt solution of the alkali may contain 0.01 wt % to 4 wt % of an alkali.

The reactive dye of the “ionic salt solution (containing reactive dye)” is an azo reactive dye, which is non-toxic and meets the requirements for contact lens formulation, and meets the regulations of the US Food and Drug Administration (FDA), For example, Reactive Blue 21, Reactive Blue No 19, Reactive Yellow 15, Reactive Orange 78, Reactive Black 5, CI Reactive Yellow 86, CI Reactive Red 11, CI Reactive Red 180, CI Reactive Blue 163, and the like. The reactive dye is also a water-soluble dye having a reactive group on a molecular structure, which can be covalently bonded or hydrogen bonded to a hydroxyl group, an amino group or a carboxy hydroxyl group in a contact lens material. In the case of the vinyl hydrazine type reactive dye, the active group contained is sulfate of an ethylene fluorenyl group (D-SO2CH═CH2) or a β-hydroxyethyl oxime group. During dyeing, β-hydroxyethyl sulfhydryl sulfate is eliminated in an alkaline medium to form an ethylene sulfhydryl group, which is then subjected to a nucleophilic addition reaction with a polymer hydroxyl group or an amino group to form a covalent bond. The ionic salt solution of the reactive dye composition may include one or more reactive dyes. The concentration of the dye may range from 0.01 wt % to 5 wt %.

“Ionic salt solution” is a commonly used buffer, and can be formulated bys such as sodium chloride, sodium hydrogen phosphate, sodium dihydrogen phosphate, sodium carbonate, potassium carbonate, boric acid, sodium tetraborate decahydrate, etc. The ionic salt solution may contain 0.01 wt % to 10 wt % of salt. The ionic salt solution provides osmotic pressure, which in turn controls the distribution of the alkali or reactive dye on the surface of the lens body, or the extent that the alkali or reactive dye enters the lens body. The ionic salt solution provides a higher osmotic pressure relative to the lens body, or a high tensile environment, such as an osmotic pressure of 300 to 800 mOsm/kg H₂O.

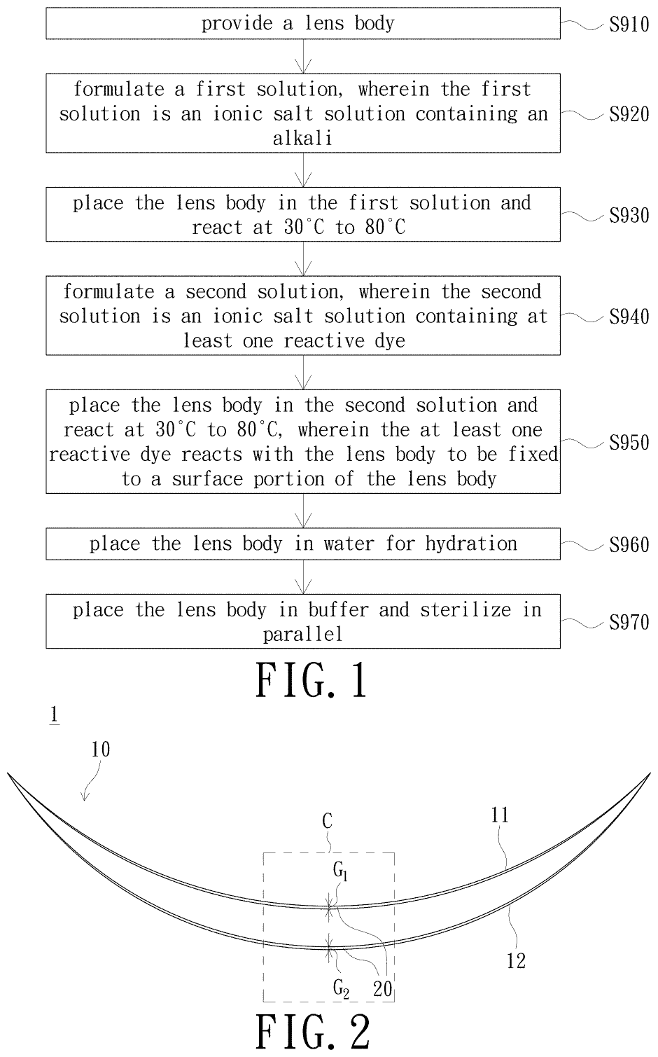

FIG. 1 is a flow chart showing a method for dyeing a functional contact lens according to an embodiment of the present invention. As shown in FIG. 1, the method includes steps S910-S970. Step S910 includes: providing a lens body. The lens body or the lens wet film body may be a commercially available contact lens such as a commercially available transparent, water blue, or colored hydrogel or silicon hydrogel contact lens (hereinafter referred to as a lens).

Any hydrogel or silicon hydrogel contact lens having specific moisture content and oxygen permeability can be used in step S910. For example, a lens having a moisture content range of 20% to 80%, an oxygen permeability (DK) range of 8×10⁻¹¹ to 188×10⁻¹¹ (cm²/sec) (ml O₂/ml×mm Hg) can be used. In an embodiment of the invention, the lens body of step S910 is a commercially available brand-A hydrogel lens having a moisture content of 38%. In another embodiment, the lens body of step S910 is a commercially available brand-B hydrogel lens having a moisture content of 58%. In yet another embodiment, the lens body of step S910 is a commercially available brand-C hydrogel color lens having a moisture content of 58%. In yet another embodiment, the lens body of step S910 is a commercially available brand-D silicon hydrogel lens having a moisture content of 56% and an oxygen permeability (DK) of 60×10⁻¹¹ (cm²/sec) (ml O₂/ml×mm Hg). In yet another embodiment, the lens body of step S910 is a commercially available brand-E having a moisture content of 38% and an oxygen permeability (DK) of 103×10⁻¹¹ (cm²/sec) (ml O₂/ml×mm Hg).

Thereafter as shown in FIG. 1, step S920 includes: formulating a first solution, wherein the first solution is an ionic salt solution containing an alkali. Sources of alkali include, but are not limited to, sodium carbonate, sodium hydrogencarbonate, sodium hydroxide, potassium carbonate. The ionic salt solution may be formulated by a salt such as sodium chloride, disodium hydrogen phosphate, sodium dihydrogen phosphate, sodium carbonate, potassium carbonate, boric acid, sodium tetraborate or the like, but is not limited thereto. Step S920 further includes: formulating an ionic salt solution having a concentration of 0.01 wt % to 10 wt %, and an ionic salt solution having a concentration of 0.01 wt % to 4 wt % alkali. The alkali ionic salt solution can be formulated with the aforementioned ionic salt solution.

Thereafter as shown in FIG. 1, step S930 includes: placing the lens body in the first solution and reacting at 30° C. to 80° C. Preferably, the reaction time is from 10 to 60 minutes. Step S930 further includes: providing an osmotic pressure, and further causing the lens body to be in a relatively high osmotic pressure environment. The osmotic pressure can be adjusted by the concentration of the ionic salt solution. In an embodiment of the invention, the osmotic pressure is 300 to 800 mOsm/kg H₂O. In step S930, the alkali of the first solution affects the surface of the lens body based on the osmotic pressure, and can help the reactive dye of the subsequent step to form a covalent bond with the hydroxyl group, the amino group, and the carboxy hydroxyl group of the lens material, and therefore has a color fixing effect.

Thereafter as shown in FIG. 1, step S940 includes: formulating a second solution, wherein the second solution is an ionic salt solution containing at least one reactive dye. The reactive dyes is selected from a group consisting of black dye, yellow dye, orange dye, blue dye and red dye or a combination thereof, and/or selected from a group consisting of anti-blue light dye, anti-blue light absorber, and ultraviolet light absorber. In an embodiment of the invention, a vinyl hydrazine dye is employed. The reactive group vinyl fluorenyl of the vinyl hydrazine dye forms a covalent bond with the hydroxyl or amino group of the lens material to achieve dyeing of the lens. The ionic salt solution may be formulated by a salt such as sodium chloride, disodium hydrogen phosphate, sodium dihydrogen phosphate, sodium carbonate, potassium carbonate, boric acid, sodium tetraborate or the like, but is not limited thereto. Step S940 further includes: formulating an ionic salt solution having a concentration of 0.01 wt % to 10 wt %, and an ionic salt solution having 0.01 wt % to 5 wt % of the reactive dye. It can be understood that the second solution of step S940 and the first solution of step S920 can be formulated together with step S930.

Thereafter as shown in FIG. 1, step S950 includes: placing the lens body in the second solution and reacting at 30° C. to 80° C. Preferably, the reaction time is from 10 to 60 minutes. Step S950 further includes: providing an osmotic pressure, and further causing the lens body to be in a relatively high osmotic pressure environment. The osmotic pressure can be adjusted by the concentration of the ionic salt solution. In an embodiment of the invention, the osmotic pressure is 300 to 800 mOsm/kg H₂O. The reactive dye of the second solution enters the lens body from the surface of the lens based on the osmotic pressure, and enters the lens body to varying degrees based on the osmotic pressure. The lens body is treated with the first solution containing an alkali in step S930, therefore in step S950, the reactive dye forms a covalent bond with the hydroxyl group, the amino group, and the carboxy hydroxyl group of the lens body and is fixed to the lens body. The procedure of alkali first and then dyeing also helps to increase the fixing rate of reactive dye and reduce the release of reactive dye.

The reactive dye bonded to the lens absorbs light of a specific wavelength range. Preferably, the specific wavelength range is in the blue wavelength range, so light having a specific wavelength is absorbed and blocked by the lens when visible light is incident on the dyed lens, and therefore the amount of light penetrating the lens is reduced.

It should be noted that although the reactive dye enters the lens body from the surface of the lens, the portion of the lens body to which the reactive dye is fixed is mainly the surface portion. Preferably, the reactive dye does not enter deep in the lens body.

Step S950 further includes: forming a dye layer on the surface of the lens body. As previously described, the reactive dye enters the lens body from the surface of the lens, as such the dye layer may have a different thickness depending on the extent to which the reactive dye enters the lens body. The extent to which the reactive dye enters the lens body and the thickness of the dye layer can be adjusted by the concentration of the ionic salt solution, the osmotic pressure, the concentration of the reactive dye, and the concentration of the alkali. The thickness of the dye layer can be determined based on the type of reactive dye and the desired light absorption.

Thereafter as shown in FIG. 1, step S960 includes: placing the lens body in the water for hydration. The water used is preferably RO water. Thereafter as shown in FIG. 1, step S970 includes: placing the lens body in buffer and sterilizing in parallel. As such, the resulting lens has an anti-blue light function and is suitable for use in environments where light is strong or full of blue light. Because blue light is the strongest part of the visible light that is closest to ultraviolet light, the adverse effects of blue light on the eyes can be reduced when the outdoor sportsmen, workers, and 3C product users wear the dyed lens in the embodiment of the present invention.

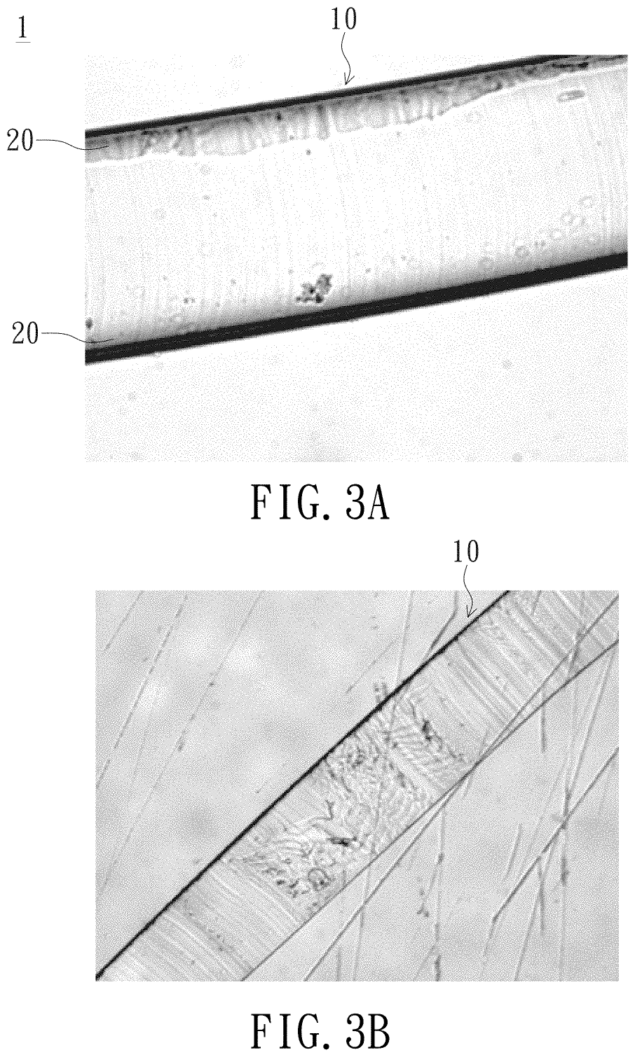

Refer to FIGS. 2 and 3A-3B. FIG. 2 is a schematic cross-sectional view of a functional contact lens according to an embodiment of the present invention. FIG. 3A is a cross-sectional photograph of a functional contact lens according to an embodiment of the present invention, wherein this photograph is taken by an optical microscope at a magnification of 100×. As shown in FIG. 2, the functional contact lens 1 includes a lens body 10 and a dye layer 20. The lens body 10 has a concave surface 11 and a convex surface 12. The dye layer 20 is disposed on the surface of the lens body 10. Specifically, the dye layer 20 has a first thickness G₁ on the concave surface 11 and a second thickness G₂ on the convex surface 12. The physical photo is shown in FIG. 3A. Compared to the un-dyed lens body of FIG. 3B, the lens surface in FIG. 3A exhibits a color (i.e., dye layer) due to the fixation of the reactive dye. In the embodiment of the present invention, the total thickness of the dye layer 20 in the central region C of the functional contact lens 1 (i.e., the sum of the first thickness G₁ and the second thickness G₂) is 0.5 μm to 40 μm. Preferably, the total thickness is not greater than 40 μm, and the first thickness G₁ and the second thickness G₂ may not be equal. For example, the dye layer 20 extends from the concave surface 11 of the lens body 10 toward the inside of the lens body 10 by a first thickness G₁ of 9 μm and extends from the convex surface 12 of the lens body 10 toward the inside of the lens body 10 by a second thickness G₂ of 11 μm. The dye layer 20 is located on the surface portion of the functional contact lens 1; therefore, even if the central portion C of the lens is inconsistent with the edge region in thickness, the overall color of the lens can be nearly uniform without the problem in which the central region C and the edge region are significantly different in color due to dyeing (i.e., annular color difference). The central region C shown in FIG. 2 is merely an illustration, and does not limit the size of the central region.

The conditions and results of dyeing according to steps S910 to S970 are further illustrated by Embodiments 1 to 5 below.

Hereunder the Embodiment 1 is described. In step S910, a commercially available brand-A hydrogel lens having a moisture content of 38% is used. In step S920, a first solution containing sodium hydroxide having an osmotic pressure of 350, 450, 550, 650, 750 mOsm/kg H₂O is formulated. In step S930, five lenses (i.e., brand-A-1, brand-A-2, brand-A-3, brand-A-4, and brand-A-5) are sequentially placed in the first solution having five different osmotic pressures. In step S940, a first solution containing a reactive dye having an osmotic pressure of 350, 450, 550, 650, 750 mOsm/kg H₂O is formulated, wherein the concentration of the reactive dye is 2 wt %. In step S950, the five lenses (i.e., brand-A-1, brand-A-2, brand-A-3, brand-A-4, and brand-A-5) are sequentially placed in the second solution having five different osmotic pressures. In step S960, the lens body is placed in RO water for hydration. In step S970, the lens body is placed in a buffer and sterilized in parallel. After the foregoing steps, the total thickness of the dye layer in the central portion of the lens is observed by using an optical microscope, and the color of the buffer after sterilization is observed. The results are shown in Table 1-1 below. As shown in Table 1-1, the thickness of the dye layer can be controlled by adjusting the osmotic pressure. Further, the reactive dye is well fixed on the surface of the lens.

Hereunder the Control Group 1 is described. In the control group, a commercially available brand-A hydrogel lens having a moisture content of 38% is also used, except that RO water is used to formulate a RO aqueous solution of reactive dye (concentration: 2 wt %) and a RO aqueous solution of alkali (hydrogen hydroxide) and the dyeing is performed with a procedure of dye treatment first and then alkali fixation. The temperature and time conditions of dye treatment and alkali fixation are the same as those in Embodiment 1. The thickness of the dye layer and the color of the buffer are also observed in the Control Group 1, and the results are shown in Table 1-2 below. As shown in Table 1-2, the thickness of the dye layer in the Control Group 1 is much greater than that in Embodiment 1. Since the lens body generally has a thickness of 80 μm to 100 μm, the results in Table 1-2 show that the Control Group 1 cannot control the dye layer on the surface portion of the lens, so the dyeing may cause a significant color difference (i.e., annular color difference) between the central region and the edge region, and therefore the appearance is affected. Further, the reactive dye is not well fixed on the surface of the lens.

TABLE 1-1

| | First | | First | Second | | Second | | |
|---|---|---|---|---|---|---|---|---|
| | solution | | solution | solution | | solution | Total | Buffer |
| | (ionic salt | | osmotic | (ionic salt | | osmotic | thickness | color after |
| | solution | | pressure | solution | | pressure | of dye | sterilization |
| Embodiment | containing | Heating | (mOsm/kg | containing | Heating | (mOsm/kg | layer | (reactive |
| 1 | an alkali) | temperature/time | H₂O) | reactive dye) | temperature/time | H₂O) | (μm) | dye release) |
| Brand-A-1 | sodium | 60° C./30 min | 350 | reactive dye | 60° C./30 min | 350 | 21 μm | transparent |
| | hydroxide | | | 2 wt % | | | | clarification |
| Brand-A-2 | sodium | 60° C./30 min | 450 | reactive dye | 60° C./30 min | 450 | 18 μm | transparent |
| | hydroxide | | | 2 wt % | | | | clarification |
| Brand-A-3 | sodium | 60° C./30 min | 550 | reactive dye | 60° C./30 min | 550 | 12 μm | transparent |
| | hydroxide | | | 2 wt % | | | | clarification |
| Brand-A-4 | sodium | 60° C./30 min | 650 | reactive dye | 60° C./30 min | 650 | 8 μm | transparent |
| | hydroxide | | | 2 wt % | | | | clarification |
| Brand-A-5 | sodium | 60° C./30 min | 750 | reactive dye | 60° C./30 min | 750 | 2 μm | transparent |
| | hydroxide | | | 2 wt % | | | | clarification |

TABLE 1-2

| | | | Osmotic | | | | | |
|---|---|---|---|---|---|---|---|---|
| | | | pressure of | | | Osmotic | | |
| | RO | | RO aqueous | | | pressure of | Total | Buffer |
| | aqueous | | solution of | | | alkaline RO | thickness | color after |
| | solution of | | reactive dye | Alkaline | | solution | of dye | sterilization |
| Control | reactive | Heating | (mOsm/kg | RO | Heating | (mOsm/kg | layer | (reactive |
| Group 1 | dye | temperature/time | H₂O) | solution | temperature/time | H₂O) | (μm) | dye release) |
| Brand-A-1 | reactive | 60° C./30 min | — | sodium | 60° C./30 min | — | 70 μm | light yellow |
| | dye 2 wt % | | | hydroxide | | | | |
| Brand-A-2 | reactive | 60° C./30 min | — | sodium | 60° C./30 min | — | 72 μm | light yellow |
| | dye 2 wt % | | | hydroxide | | | | |
| Brand-A-3 | reactive | 60° C./30 min | — | sodium | 60° C./30 min | — | 70 μm | light yellow |
| | dye 2 wt % | | | hydroxide | | | | |
| Brand-A-4 | reactive | 60° C./30 min | — | sodium | 60° C./30 min | — | 67 μm | light yellow |
| | dye 2 wt % | | | hydroxide | | | | |
| Brand-A-5 | reactive | 60° C./30 min | — | sodium | 60° C./30 min | — | 73 μm | light yellow |
| | dye 2 wt % | | | hydroxide | | | | |

Hereunder the Embodiment 2 is described. In step S910, a commercially available brand-B hydrogel lens having a moisture content of 58% is used. The step S920 in the Embodiment 2 is the same as the step S920 in the Embodiment 1. In step S930, five lenses (i.e., brand-B-1, brand-B-2, brand-B-3, brand-B-4, and brand-B-5) are sequentially placed in the first solution having five different osmotic pressures. The step S940 in the Embodiment 2 is the same as the step S940 in the Embodiment 1. In step S950, the five lenses (i.e., brand-B-1, brand-B-2, brand-B-3, brand-B-4, and brand-B-5) are sequentially placed in the second solution. The steps S960 and S970 in the Embodiment 2 are the same as the steps S960 and S970 in the Embodiment 1, respectively. After the foregoing steps, the total thickness of the dye layer in the central portion of the lens is observed by using an optical microscope, and the color of the buffer after sterilization is observed. The results are shown in Table 2-1 below. As shown in Table 2-1, the thickness of the dye layer can be controlled by adjusting the osmotic pressure. Further, the reactive dye is well fixed on the surface of the lens.

Hereunder the Control Group 2 is described. In the control group, a commercially available brand-B hydrogel lens having a moisture content of 58% is also used, except that RO water is used to formulate a RO aqueous solution of reactive dye (concentration: 2 wt %) and a RO aqueous solution of alkali (hydrogen hydroxide) and the dyeing is performed with a procedure of dye treatment first and then alkali fixation. The temperature and time conditions of dye treatment and alkali fixation are the same as those in Embodiment 2. As shown in Table 2-2, the thickness of the dye layer in the Control Group 2 is much greater than that in Embodiment 2. The Control Group 2 cannot control the dye layer on the surface portion of the lens, and the reactive dye is not well fixed on the surface of the lens.

TABLE 2-1

| | First | | First | Second | | Second | | |
|---|---|---|---|---|---|---|---|---|
| | solution | | solution | solution | | solution | Total | Buffer |
| | (ionic salt | | osmotic | (ionic salt | | osmotic | thickness | color after |
| | solution | | pressure | solution | | pressure | of dye | sterilization |
| Embodiment | containing | Heating | (mOsm/kg | containing | Heating | (mOsm/kg | layer | (reactive |
| 2 | an alkali) | temperature/time | H₂O) | reactive dye) | temperature/time | H₂O) | (μm) | dye release) |
| Brand-B-1 | sodium | 60° C./30 min | 350 | reactive dye | 60° C./30 min | 350 | 20 μm | transparent |
| | hydroxide | | | 2 wt % | | | | clarification |
| Brand-B-2 | sodium | 60° C./30 min | 450 | reactive dye | 60° C./30 min | 450 | 17 μm | transparent |
| | hydroxide | | | 2 wt % | | | | clarification |
| Brand-B-3 | sodium | 60° C./30 min | 550 | reactive dye | 60° C./30 min | 550 | 15 μm | transparent |
| | hydroxide | | | 2 wt % | | | | clarification |
| Brand-B-4 | sodium | 60° C./30 min | 650 | reactive dye | 60° C./30 min | 650 | 10 μm | transparent |
| | hydroxide | | | 2 wt % | | | | clarification |
| Brand-B-5 | sodium | 60° C./30 min | 750 | reactive dye | 60° C./30 min | 750 | 5 μm | transparent |
| | hydroxide | | | 2 wt % | | | | clarification |

TABLE 2-2

| | | | Osmotic | | | | | |
|---|---|---|---|---|---|---|---|---|
| | | | pressure of | | | Osmotic | | |
| | RO | | RO aqueous | | | pressure of | Total | Buffer |
| | aqueous | | solution of | | | alkaline RO | thickness | color after |
| | solution of | | reactive dye | Alkaline | | solution | of dye | sterilization |
| Control | reactive | Heating | (mOsm/kg | RO | Heating | (mOsm/kg | layer | (reactive |
| Group 2 | dye | temperature/time | H₂O) | solution | temperature/time | H₂O) | (μm) | dye release) |
| Brand-B-1 | reactive | 60° C./30 min | — | sodium | 60° C./30 min | — | 78 μm | light yellow |
| | dye 2 wt % | | | hydroxide | | | | |
| Brand-B-2 | reactive | 60° C./30 min | — | sodium | 60° C./30 min | — | 76 μm | light yellow |
| | dye 2 wt % | | | hydroxide | | | | |
| Brand-B-3 | reactive | 60° C./30 min | — | sodium | 60° C./30 min | — | 77 μm | light yellow |
| | dye 2 wt % | | | hydroxide | | | | |
| Brand-B-4 | reactive | 60° C./30 min | — | sodium | 60° C./30 min | — | 76 μm | light yellow |
| | dye 2 wt % | | | hydroxide | | | | |
| Brand-B-5 | reactive | 60° C./30 min | — | sodium | 60° C./30 min | — | 79 μm | light yellow |
| | dye 2 wt % | | | hydroxide | | | | |

Hereunder the Embodiment 3 is described. In step S910, a commercially available brand-C hydrogel color lens having a moisture content of 58% is used. The step S920 in the Embodiment 3 is the same as the step S920 in the above Embodiments. In step S930, five lenses (i.e., brand-C-1, brand-C-2, brand-C-3, brand-C-4, and brand-C-5) are sequentially placed in the first solution having five different osmotic pressures. The step S940 in the Embodiment 3 is the same as the step S940 in the above Embodiments. In step S950, the five lenses (i.e., brand-C-1, brand-C-2, brand-C-3, brand-C-4, and brand-C-5) are sequentially placed in the second solution having five different osmotic pressures. The steps S960 and S970 in the Embodiment 3 are the same as the steps S960 and S970 in the above Embodiments, respectively. After the foregoing steps, the total thickness of the dye layer in the central portion of the lens is observed by using an optical microscope, and the color of the buffer after sterilization is observed. The results are shown in Table 3-1 below. As shown in Table 3-1, the thickness of the dye layer can be controlled by adjusting the osmotic pressure. Further, the reactive dye is well fixed on the surface of the lens.

Hereunder the Control Group 3 is described. In the control group, a commercially available brand-C hydrogel color lens having a moisture content of 58% is also used, except that RO water is used to formulate a RO aqueous solution of reactive dye (concentration: 2 wt %) and a RO aqueous solution of alkali (hydrogen hydroxide) and the dyeing is performed with a procedure of dye treatment first and then alkali fixation. The temperature and time conditions of dye treatment and alkali fixation are the same as those in Embodiment 3. As shown in Table 3-2, the thickness of the dye layer in the Control Group 3 is much greater than that in Embodiment 3. The Control Group 3 cannot control the dye layer on the surface portion of the lens, and the reactive dye is not well fixed on the surface of the lens.

TABLE 3-1

| | First | | First | Second | | Second | | |
|---|---|---|---|---|---|---|---|---|
| | solution | | solution | solution | | solution | Total | Buffer |
| | (ionic salt | | osmotic | (ionic salt | | osmotic | thickness | color after |
| | solution | | pressure | solution | | pressure | of dye | sterilization |
| Embodiment | containing | Heating | (mOsm/kg | containing | Heating | (mOsm/kg | layer | (reactive |
| 3 | an alkali) | temperature/time | H₂O) | reactive dye) | temperature/time | H₂O) | (μm) | dye release) |
| Brand-C-1 | sodium | 60° C./30 min | 350 | reactive dye | 60° C./30 min | 350 | 21 μm | transparent |
| | hydroxide | | | 2 wt % | | | | clarification |
| Brand-C-2 | sodium | 60° C./30 min | 450 | reactive dye | 60° C./30 min | 450 | 17 μm | transparent |
| | hydroxide | | | 2 wt % | | | | clarification |
| Brand-C-3 | sodium | 60° C./30 min | 550 | reactive dye | 60° C./30 min | 550 | 16 μm | transparent |
| | hydroxide | | | 2 wt % | | | | clarification |
| Brand-C-4 | sodium | 60° C./30 min | 650 | reactive dye | 60° C./30 min | 650 | 12 μm | transparent |
| | hydroxide | | | 2 wt % | | | | clarification |
| Brand-C-5 | sodium | 60° C./30 min | 750 | reactive dye | 60° C./30 min | 750 | 4 μm | transparent |
| | hydroxide | | | 2 wt % | | | | clarification |

TABLE 3-2

| | | | Osmotic | | | | | |
|---|---|---|---|---|---|---|---|---|
| | | | pressure of | | | Osmotic | | |
| | RO | | RO aqueous | | | pressure of | Total | Buffer |
| | aqueous | | solution of | | | alkaline RO | thickness | color after |
| | solution of | | reactive dye | Alkaline | | solution | of dye | sterilization |
| Control | reactive | Heating | (mOsm/kg | RO | Heating | (mOsm/kg | layer | (reactive |
| Group 3 | dye | temperature/time | H₂O) | solution | temperature/time | H₂O) | (μm) | dye release) |
| Brand-C-1 | reactive | 60° C./30 min | — | sodium | 60° C./30 min | — | 75 μm | light yellow |
| | dye 2 wt % | | | hydroxide | | | | |
| Brand-C-2 | reactive | 60° C./30 min | — | sodium | 60° C./30 min | — | 76 μm | light yellow |
| | dye 2 wt % | | | hydroxide | | | | |
| Brand-C-3 | reactive | 60° C./30 min | — | sodium | 60° C./30 min | — | 76 μm | light yellow |
| | dye 2 wt % | | | hydroxide | | | | |
| Brand-C-4 | reactive | 60° C./30 min | — | sodium | 60° C./30 min | — | 78 μm | light yellow |
| | dye 2 wt % | | | hydroxide | | | | |
| Brand-C-5 | reactive | 60° C./30 min | — | sodium | 60° C./30 min | — | 74 μm | light yellow |
| | dye 2 wt % | | | hydroxide | | | | |

Hereunder the Embodiment 4 is described. In step S910, a commercially available brand-D silicon hydrogel lens having a moisture content of 58% and an oxygen permeability (DK) of 60×10⁻¹¹ (cm²/sec) (ml O₂/ml×mm Hg) is used. The step S920 in the Embodiment 4 is the same as the step S920 in the above Embodiments. In step S930, five lenses (i.e., brand-D-1, brand-D-2, brand-D-3, brand-D-4, and brand-D-5) are sequentially placed in the first solution having five different osmotic pressures. The step S940 in the Embodiment 4 is the same as the step S940 in the above Embodiments. In step S950, the five lenses (i.e., brand-D-1, brand-D-2, brand-D-3, brand-D-4, and brand-D-5) are sequentially placed in the second solution having five different osmotic pressures. The steps S960 and S970 in the Embodiment 4 are the same as the steps S960 and S970 in the above Embodiments, respectively. After the foregoing steps, the total thickness of the dye layer in the central portion of the lens is observed by using an optical microscope, and the color of the buffer after sterilization is observed. The results are shown in Table 4-1 below. As shown in Table 4-1, the thickness of the dye layer can be controlled by adjusting the osmotic pressure. Further, the reactive dye is well fixed on the surface of the lens.

Hereunder the Control Group 4 is described. In the control group, a commercially available brand-D silicon hydrogel lens having a moisture content of 58% and an oxygen permeability (DK) of 60×10⁻¹¹ (cm²/sec) (ml O₂/ml×mm Hg) is also used, except that RO water is used to formulate a RO aqueous solution of reactive dye and a RO aqueous solution of alkali and the dyeing is performed with a procedure of dye treatment first and then alkali fixation. The temperature and time conditions of dye treatment and alkali fixation are the same as those in Embodiment 4. As shown in Table 4-2, the thickness of the dye layer in the Control Group 4 is much greater than that in Embodiment 4. The Control Group 4 cannot control the dye layer on the surface portion of the lens, and the reactive dye is not well fixed on the surface of the lens.

TABLE 4-1

| | First | | First | Second | | Second | | |
|---|---|---|---|---|---|---|---|---|
| | solution | | solution | solution | | solution | Total | Buffer |
| | (ionic salt | | osmotic | (ionic salt | | osmotic | thickness | color after |
| | solution | | pressure | solution | | pressure | of dye | sterilization |
| Embodiment | containing | Heating | (mOsm/kg | containing | Heating | (mOsm/kg | layer | (reactive |
| 4 | an alkali) | temperature/time | H₂O) | reactive dye) | temperature/time | H₂O) | (μm) | dye release) |
| Brand-D-1 | sodium | 60° C./30 min | 350 | reactive dye | 60° C./30 min | 350 | 18 μm | transparent |
| | hydroxide | | | 2 wt % | | | | clarification |
| Brand-D-2 | sodium | 60° C./30 min | 450 | reactive dye | 60° C./30 min | 450 | 14 μm | transparent |
| | hydroxide | | | 2 wt % | | | | clarification |
| Brand-D-3 | sodium | 60° C./30 min | 550 | reactive dye | 60° C./30 min | 550 | 11 μm | transparent |
| | hydroxide | | | 2 wt % | | | | clarification |
| Brand-D-4 | sodium | 60° C./30 min | 650 | reactive dye | 60° C./30 min | 650 | 9 μm | transparent |
| | hydroxide | | | 2 wt % | | | | clarification |
| Brand-D-5 | sodium | 60° C./30 min | 750 | reactive dye | 60° C./30 min | 750 | 3 μm | transparent |
| | hydroxide | | | 2 wt % | | | | clarification |

TABLE 4-2

| | | | Osmotic | | | | | |
|---|---|---|---|---|---|---|---|---|
| | | | pressure of | | | Osmotic | | |
| | RO | | RO aqueous | | | pressure of | Total | Buffer |
| | aqueous | | solution of | | | alkaline RO | thickness | color after |
| | solution of | | reactive dye | Alkaline | | solution | of dye | sterilization |
| Control | reactive | Heating | (mOsm/kg | RO | Heating | (mOsm/kg | layer | (reactive |
| Group 4 | dye | temperature/time | H₂O) | solution | temperature/time | H₂O) | (μm) | dye release) |
| Brand-D-1 | reactive | 60° C./30 min | — | sodium | 60° C./30 min | — | 60 μm | light yellow |
| | dye 2 wt % | | | hydroxide | | | | |
| Brand-D-2 | reactive | 60° C./30 min | — | sodium | 60° C./30 min | — | 62 μm | light yellow |
| | dye 2 wt % | | | hydroxide | | | | |
| Brand-D-3 | reactive | 60° C./30 min | — | sodium | 60° C./30 min | — | 65 μm | light yellow |
| | dye 2 wt % | | | hydroxide | | | | |
| Brand-D-4 | reactive | 60° C./30 min | — | sodium | 60° C./30 min | — | 59 μm | light yellow |
| | dye 2 wt % | | | hydroxide | | | | |
| Brand-D-5 | reactive | 60° C./30 min | — | sodium | 60° C./30 min | — | 63 μm | light yellow |
| | dye 2 wt % | | | hydroxide | | | | |

Hereunder the Embodiment 5 is described. In step S910, a commercially available brand-E silicon hydrogel lens having a moisture content of 38% and an oxygen permeability (DK) of 103×10⁻¹¹ (cm²/sec) (ml O₂/ml×mm Hg) is used. The step S920 in the Embodiment 4 is the same as the step S920 in the above Embodiments. In step S930, five lenses (i.e., brand-E-1, brand-E-2, brand-E-3, brand-E-4, and brand-E-5) are sequentially placed in the first solution having five different osmotic pressures. The step S940 in the Embodiment 5 is the same as the step S940 in the above Embodiments. In step S950, the five lenses (i.e., brand-E-1, brand-E-2, brand-E-3, brand-E-4, and brand-E-5) are sequentially placed in the second solution having five different osmotic pressures. The steps S960 and S970 in the Embodiment 5 are the same as the steps S960 and S970 in the above Embodiments, respectively. After the foregoing steps, the total thickness of the dye layer in the central portion of the lens is observed by using an optical microscope, and the color of the buffer after sterilization is observed. The results are shown in Table 4-1 below. As shown in Table 5-1, the thickness of the dye layer can be controlled by adjusting the osmotic pressure. Further, the reactive dye is well fixed on the surface of the lens.

Hereunder the Control Group 5 is described. In the control group, a commercially available brand-E silicon hydrogel lens having a moisture content of 38% and an oxygen permeability (DK) of 103×10⁻¹¹ (cm²/sec) (ml O₂/ml×mm Hg) is also used, except that RO water is used to formulate a RO aqueous solution of reactive dye and a RO aqueous solution of alkali and the dyeing is performed with a procedure of dye treatment first and then alkali fixation. The temperature and time conditions of dye treatment and alkali fixation are the same as those in Embodiment 5. As shown in Table 5-2, the thickness of the dye layer in the Control Group 5 is much greater than that in Embodiment 5. The Control Group 5 cannot control the dye layer on the surface portion of the lens, and the reactive dye is not well fixed on the surface of the lens.

TABLE 5-1

| | First | | First | Second | | Second | | |
|---|---|---|---|---|---|---|---|---|
| | solution | | solution | solution | | solution | Total | Buffer |
| | (ionic salt | | osmotic | (ionic salt | | osmotic | thickness | color after |
| | solution | | pressure | solution | | pressure | of dye | sterilization |
| Embodiment | containing | Heating | (mOsm/kg | containing | Heating | (mOsm/kg | layer | (reactive |
| 5 | an alkali) | temperature/time | H₂O) | reactive dye) | temperature/time | H₂O) | (μm) | dye release) |
| Brand-E-1 | sodium | 60° C./30 min | 350 | reactive dye | 60° C./30 min | 350 | 18 μm | transparent |
| | hydroxide | | | 2 wt % | | | | clarification |
| Brand-E-2 | sodium | 60° C./30 min | 450 | reactive dye | 60° C./30 min | 450 | 15 μm | transparent |
| | hydroxide | | | 2 wt % | | | | clarification |
| Brand-E-3 | sodium | 60° C./30 min | 550 | reactive dye | 60° C./30 min | 550 | 12 μm | transparent |
| | hydroxide | | | 2 wt % | | | | clarification |
| Brand-E-4 | sodium | 60° C./30 min | 650 | reactive dye | 60° C./30 min | 650 | 7 μm | transparent |
| | hydroxide | | | 2 wt % | | | | clarification |
| Brand-E-5 | sodium | 60° C./30 min | 750 | reactive dye | 60° C./30 min | 750 | 1 μm | transparent |
| | hydroxide | | | 2 wt % | | | | clarification |

TABLE 5-2

| | | | Osmotic | | | | | |
|---|---|---|---|---|---|---|---|---|
| | | | pressure of | | | Osmotic | | |
| | RO | | RO aqueous | | | pressure of | Total | Buffer |
| | aqueous | | solution of | | | alkaline RO | thickness | color after |
| | solution of | | reactive dye | Alkaline | | solution | of dye | sterilization |
| Control | reactive | Heating | (mOsm/kg | RO | Heating | (mOsm/ | layer | (reactive |
| Group 5 | dye | temperature/time | H₂O) | solution | temperature/time | kg H₂O) | (μm) | dye release) |
| Brand-E-1 | reactive | 60° C./30min | — | sodium | 60° C./30 min | — | 68 μm | light yellow |
| | dye 2 wt % | | | hydroxide | | | | |
| Brand-E-2 | reactive | 60° C./30 min | — | sodium | 60° C./30 min | — | 69 μm | light yellow |
| | dye 2 wt % | | | hydroxide | | | | |
| Brand-E-3 | reactive | 60° C./30 min | — | sodium | 60° C./30 min | — | 65 μm | light yellow |
| | dye 2 wt % | | | hydroxide | | | | |
| Brand-E-4 | reactive | 60° C./30 min | — | sodium | 60° C./30 min | — | 64 μm | light yellow |
| | dye 2 wt % | | | hydroxide | | | | |
| Brand-E-5 | reactive | 60° C./30 min | — | sodium | 60° C./30 min | — | 67 μm | light yellow |
| | dye 2 wt % | | | hydroxide | | | | |

In summary, the dyeing method of the embodiment of the present invention can be applied to various materials and the lenses having different moisture contents and different oxygen permeability, and the reactive dyes are not significantly released and no safety problem. The formulated functional contact lens has higher market acceptance because the dyeing layer is located on the surface portion of the lens, thereby improving the color uniformity of the appearance of the lens, and the lens is more beautiful.

The functional contact lens of the embodiment of the invention and the functional contact lens produced by the dyeing method embodiment have the function of anti-blue light. Further, by adjusting the ratio of each reactive dye (such as black, yellow, orange, blue, red dye) and the amount of reactive dyes, different absorption/transmission ratios of the lenses for different wavelength ranges of light is obtained. The effects of different reactive dyes on the light transmittance are exemplified below by Embodiments 6 and 7.

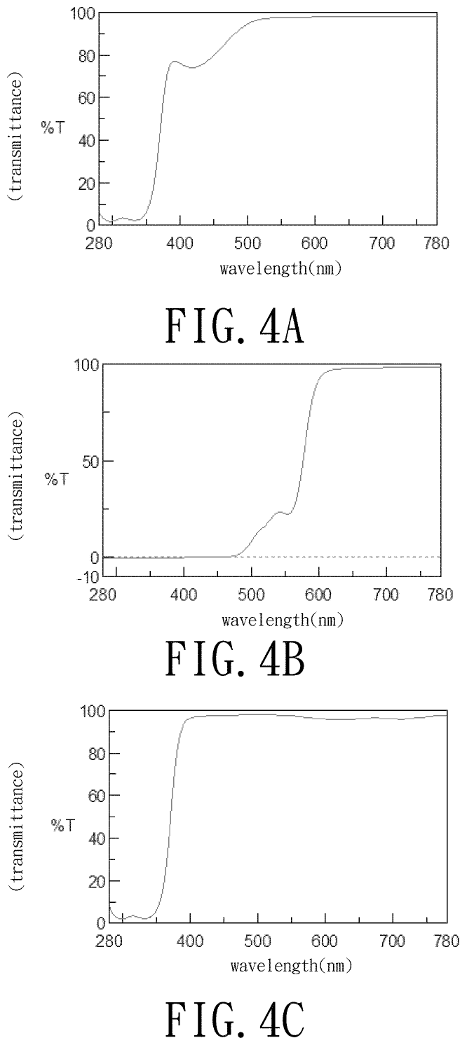

Hereunder the Embodiment 6 is described. According to the foregoing steps S910 to S970, the second solution is formulated with a yellow dye for dyeing. Then, the obtained functional contact lens is tested for light transmittance, and the results are shown in FIG. 4A. As shown in FIG. 4A, the functional contact lens of Embodiment 6 absorbs light of a specific wavelength range. This specific wavelength range is in the blue wavelength range, and the shielding rate of light in the wavelength range of 380 nm to 500 nm is observed to be greater than 5%. Preferably, the transmittance of light in the wavelength range of 380 nm to 500 nm is also reduced by about 20%. Based on this result, the functional contact lens of the embodiments of the present invention has an anti-blue light effect.

Hereunder the Embodiment 7 is described. According to the foregoing steps S910 to S970, a plurality of reactive dyes is combined to formulate a second solution having a reactive dye concentration of 2 wt % for dyeing. Then, the obtained functional contact lens is tested for light transmittance, and the results are shown in FIG. 4B. As shown in FIG. 4B, the functional contact lens of Embodiment 7 absorbs light of a specific wavelength range, wherein the shielding ratio of the light having a wavelength range of 380 nm to 780 nm is at most 70% and preferably not more than 70%, and the transmittance of light having a wavelength range of 380 nm to 500 nm approaches zero (0%). Based on this result, the functional contact lens of the embodiments of the present invention are suitable as a sun contact lens to protect the wearer from the adverse effects of strong light on the eyes. In addition, because also having the effect of improving visual contrast sensitivity, reducing reflection glare, and increasing color contrast, the functional contact lens of the embodiments of the present invention is also suitable for outdoor sports, which can improve sports performance.

Hereunder the Control Group 6 is described. As shown in FIG. 4C, compared with Embodiment 6 and 7, visible light has a transmittance of greater than 90% in the un-dyed lens body, and therefore, light in the blue wavelength range has a greater probability of penetrating the lens and affecting the eye.

In summary, the present invention provides a method for dyeing a functional contact lens, in which the thickness of the dye layer is controlled by controlling the alkali or reactive dye on the surface portion of the lens by the high osmotic pressure of the ions. The procedure of alkali first and then dyeing allows the reactive dye to be effectively fixed to the surface portion of the lens to reduce dye release. The dyeing method of the invention helps to overcome the annular color difference of the lens color caused by the difference in thickness of the contact lens and improves the color uniformity, thereby providing a contact lens which is both aesthetic and anti-blue light.

The above is only the preferred embodiment of the present invention, and the scope of the present invention is not limited thereto. That is, the simple equivalent change and modifications according to the scope of the present invention and the description of the invention are still within the scope of the invention patent. In addition, any of the objects or advantages or features of the present invention are not required to be achieved by any embodiment or application of the invention. In addition, the Abstract and Title are only used to assist in the search of patent documents and are not intended to limit the scope of the invention. In addition, the terms “first” and “second” as used in the specification or the scope of the patent application are used only to name the elements or to distinguish different embodiments or ranges, and are not intended to limit the upper or lower limit number of elements.

What is claimed is:

1. A method for dyeing a functional contact lens, comprising steps of:
providing a lens body;
formulating a first solution, wherein the first solution is an ionic salt solution containing an alkali;
placing the lens body in the first solution and reacting at 30° C. to 80° C.;
formulating a second solution, wherein the second solution is an ionic salt solution containing at least one reactive dye; and
placing the lens body in the second solution and reacting at 30° C. to 80° C.;
wherein the at least one reactive dye reacts with the lens body to be fixed to a surface portion of the lens body.

2. The method for dyeing a functional contact lens according to claim 1, further comprising a step of: placing the lens body in the first solution and reacting at 30° C. to 80° C. for 10 to 60 minutes.

3. The method for dyeing a functional contact lens according to claim 1, further comprising a step of: placing the lens body in the second solution and reacting at 30° C. to 80° C. for 10 to 60 minutes.

4. The method for dyeing a functional contact lens according to claim 1, wherein the step of placing the lens body in the second solution and reacting at 30° C. to 80° C. further comprises a step of: forming a dye layer on the surface portion of the lens body.

5. The method for dyeing a functional contact lens according to claim 4, wherein a thickness of the dye layer is 0.5 um to 40 μm.

6. The method for dyeing a functional contact lens according to claim 1, wherein a concentration of the alkali of the first solution is 0.01 wt % to 4 wt %, and a concentration of an ionic salt thereof is 0.01 wt % to 10 wt %.

7. The method for dyeing a functional contact lens according to claim 1, wherein a concentration of the that least one reactive dye of the second solution is 0.01 wt % to 5 wt %, and a concentration of an ionic salt thereof is 0.01 wt % to 10 wt %.

8. The method for dyeing a functional contact lens according to claim 1, wherein the first solution has an osmotic pressure of 300 to 800 mOsm/kg H₂O.

9. The method for dyeing a functional contact lens according to claim 1, wherein the second solution has an osmotic pressure of 300 to 800 mOsm/kg H₂O.

10. The method for dyeing a functional contact lens according to claim 1, wherein the reactive dye is selected from a group consisting of a black dye, a yellow dye, an orange dye, a blue dye, and a red dye or a combination thereof.

11. The method for dyeing a functional contact lens according to claim 6, wherein the first solution contains sodium carbonate, sodium bicarbonate, sodium hydroxide, potassium carbonate, boric acid, sodium tetraborate or a combination thereof, and the second solution contains sodium carbonate, sodium bicarbonate, sodium hydroxide, potassium carbonate, boric acid, sodium tetraborate or a combination thereof.

12. The method for dyeing a functional contact lens according to claim 7, wherein the first solution contains sodium carbonate, sodium bicarbonate, sodium hydroxide, potassium carbonate, boric acid, sodium tetraborate or a combination thereof, and the second solution contains sodium carbonate, sodium bicarbonate, sodium hydroxide, potassium carbonate, boric acid, sodium tetraborate or a combination thereof.

13. The method for dyeing a functional contact lens according to claim 1, wherein the lens body has a moisture content of 20% to 80%.

14. The method for dyeing a functional contact lens according to claim 1, wherein the lens body has an oxygen permeability range of 8×10⁻¹¹ to 188×10⁻¹¹ (cm²/sec) (ml O₂/ml×mm Hg).

15. The method for dyeing a functional contact lens according to claim 1, further comprising a step of: placing the lens body in water for hydration.

16. The method for dyeing a functional contact lens according to claim 15, further comprising the step of: placing the lens body in a buffer and sterilizing in parallel.

17. A functional contact lens comprising a lens body and a dye layer disposed on a surface portion of the lens body, and the functional contact lens is manufactured by a method comprising steps of:
providing a lens body;
formulating a first solution, wherein the first solution is an ionic salt solution containing an alkali;
placing the lens body in the first solution and reacting at 30° C. to 80° C.;
formulating a second solution, wherein the second solution is an ionic salt solution containing at least one reactive dye; and
placing the lens body in the second solution and reacting at 30° C. to 80° C.;
wherein the at least one reactive dye reacts with the lens body to be fixed to a surface portion of the lens body.

18. The functional contact lens according to claim 17, wherein the dye layer has a thickness of 0.5 μm to 40 μm.

19. The functional contact lens according to claim 17, wherein the lens body comprises a concave surface and a convex surface, the dye layer extends from the concave surface toward an inside of the lens body by a first thickness and extends from the convex surface toward the inside of the lens body by a second thickness, and a sum of the first thickness and the second thickness is less than 40 μm.

20. A functional contact lens comprising a lens body and a dye layer disposed on a surface portion of the lens body, and the lens body comprising:
a concave surface, wherein the dye layer extends from the concave surface toward an inside of the lens body by a first thickness; and
a convex surface, wherein the dye layer extends from the convex surface toward the inside of the lens body by a second thickness;
wherein a sum of the first thickness and the second thickness is less than 40 μm, and light having a wavelength in a range of 380 nm to 500 nm has a shielding ratio greater than 5% for the functional contact lens.

21. The functional contact lens according to claim 20, wherein a transmittance of light in a wavelength range of 380 nm to 500 nm approaches 0% in the functional contact lens, and the functional contact lens has a shielding ratio of less than 70% for light in a wavelength range 380 nm to 780 nm.
